(19) United States
(12) Patent Application Publication
(10) Pub. No.: US 2012/0072933 A1
(43) Pub. Date: Mar. 22, 2012

(54) System for Subscriber-Specific TV and Multimedia Content Distribution Over High Speed Broadcast Mediums

(75) Inventor: Beau K. MOORE, Apopka, FL (US)

(73) Assignee: PLATFORM DESIGN, INC., Altamonte Springs, FL (US)

(21) Appl. No.: 13/077,801

(22) Filed: Mar. 31, 2011

Related U.S. Application Data
(60) Provisional application No. 61/319,437, filed on Mar. 31, 2010.

(51) Int. Cl. H04N 21/2543; H04N 21/80

(52) U.S. Cl. 725/1; 725/60

(57) ABSTRACT

Systems, management and distribution methodologies (including both hardware and software components) for the delivery of subscriber-specific TV and multimedia broadcasts. The system delivers multimedia files, regardless of compression or format, to subscribers; instead of normal linear broadcasts or content streaming. Delayed Negative Acknowledgment allows the client application to request any missing packets via a low speed return path to the TV Aggregation Servers. These negative acknowledgments are aggregated over a long delay period based on the initial broadcasts' time to live. Once a considerable threshold has been reached the missing content is rebroadcast, clients receive any missing packets and mark the initial broadcast as complete thus making it available for viewing.

### CROSS REFERENCE TO RELATED APPLICATIONS

This invention claims the benefit of priority to U.S. Provisional Patent Application 61/319,437 filed Mar. 31, 2010.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to cable and satellite broadcast satellite systems, and more particularly to an efficient, reliable, low-cost method of distribution for binary data, primarily customized entertainment video and other format selections, unhampered by any topographical or terrestrial infrastructure limitations.

### BACKGROUND INFORMATION AND DISCUSSION OF RELATED ART

In existing satellite networks, the available satellite bandwidth varies significantly from satellite to satellite, and is used as a streaming method for the entire period of the content delivery. Despite the intrinsic latency due to the vertical distance of the satellite from the receiving application, this is essentially real-time delivery using DVBS protocols for content streaming. Using the satellite capacity in this manner is not efficient because of the failure to develop and employ effective compression techniques. Current satellite systems can grow market share only by increasing compression or by placing new satellites in orbit. Either of these strategies requires extensive technological and financial resources.

Cable TV systems function in a manner very similar to satellite systems, but the cable systems are limited strictly by existing infrastructure. The cable TV systems use ATSC and NTSC standards for content streaming. The expansion of the cable TV system is extremely expensive, although the investment continues to be made.

IP TV is a system and supporting technologies in which digital television is delivered real-time over the internet using IP protocols. There are several entrepreneurial ventures currently attempting to use the Internet in the same manner as satellite or cable use their respective infrastructures to broadcast binary entertainment data. However, there is neither enough Internet capacity from one end point to any and all other end points presently nor any redeeming new technology anywhere on the near-term horizon that could offset this lack of Internet capacity. The Internet was not built for this type of use; the infrastructure is simply limited.

The foregoing discussion reflects the current state of the art of which the present inventor is aware. Reference to, and discussion of, this information is intended to aid in discharging the Applicant's acknowledged duty of candor in disclosing information that may be relevant to the examination of claims to the present invention. However, it is respectfully submitted that none of the above-indicated information discloses, teaches, suggests, shows, or otherwise renders obvious, either singly or when considered in combination, the invention described and claimed herein.

### SUMMARY OF THE INVENTION

The present invention provides a highly integrated set of innovative and comprehensive management and distribution methodologies and systems (including both hardware and software components) for the delivery of subscriber-specific TV and multimedia broadcasts. The methodologies and systems deliver multimedia files, regardless of compression or format, to subscribers; instead of normal linear broadcasts or content streaming.

Overview. The methodologies and systems involve and utilize features and components including the following:

TV Protocol with Delayed Negative Acknowledgment:

TV Protocol is the core delivery mechanism of the TV Content Delivery Service. It utilizes any high capacity transport medium (DVB Satellite in the TV Service) to deliver content to a client application via UDP Broadcast. UDP Broadcast is traditionally a non-guaranteed delivery. However the added benefit of Delayed Negative Acknowledgment allows the client application to request any missing packets via a low speed return path to the TV Aggregation Servers. These delayed negative acknowledgments are aggregated over a long delay period (as much as 24 hours) based on the initial broadcasts' time to live. Once a considerable threshold of Delayed Negative Acknowledgements has been reached the missing content is rebroadcast, clients receive any missing packets and mark the initial broadcast as complete making it available for viewing.

TV Content Management System:

The TV Content Management System is a system of broadcasting content that is normally repeatedly broadcast on traditional systems in real-time, one time using the TV Protocol. This TV Content Management System allows the subscribers to receive only content they choose to receive, providing a true a la cart content delivery system.

TV Timeless Program Guide:

The TV Timeless Program Guides provides a system for accessing pushed content on a client set-top box or receiver. This system allows the user to access a program guide that looks and functions like a traditional linear electronic program guide. This guide has the added benefit of allowing the user the ability to access and view content that well-after its initial broadcast time. The entire guide consists of and is based on content that has been delivered earlier using the TV Protocol.

TV Terrestrial Supplementation:

Another feature involves the provision of TV Terrestrial Supplementation. Depending on the number of subscribers missing packets in a given TV Protocol package, this TV Terrestrial Supplementation enables the client system to request the missing parts from strategically located, high-capacity TV data repositories via a secure private network over the Internet.

TV Peer-To-Peer Supplementation:

Depending on the size of missing packets in a given TV Protocol package, another feature, TV Peer-To-Peer Supplementation allows the client system—to request the missing parts from other peers via a secure private peer-to-peer network over the Internet.

TV Dead-end Supplementation for DVB Broadcast Systems:

The TV Protocol operates without requiring a return path to relay Delayed Negative Acknowledgments. As long as there are clients in the broadcast's initial delivery footprint that have a return path then statistically those clients will have similar Delayed Negative Acknowledgments that will be relayed, thus triggering a rebroadcast from the TV Servers over the Broadcast medium. This is referred to as TV Dead-end Supplementation for DVB Broadcast Systems.

VOIP over 1-Way Satellite Service using Terrestrial Return Channel:

Also provided with the inventive methodologies and systems is a system and method for providing Voice Over IP (VOIP) to one-way internet satellite customers. A one-way satellite internet service typically uses the satellite link to provide a high speed, broadband downlink to users. The uplink in such one-way service is usually a slower 50 kbps phone line (dialup) service. By properly configuring ports on the user/home box and associated embedded communications software, in the systems and methodologies of the invention, the phone line will function as both a dial-up based Internet uplink channel, and a two-way VOW channel that enables two-way digital voice service with all of the normal features and benefits.

802.1 IN Wireless Storage Expandability

The TV Set top box will offer the ability to expand the amount of storage available for content by simply adding a TV 802.11N Wireless Expansion Module of the type readily available. This TV Set top box consists of a 300 GB to ITB hard disk drive, controller board and 802.11N receiver that is compatible with the 802.11N receiver in the TV Set top box.

TV Protocol utilizes high-speed transmission bandwidth to its fullest potential by making User Datagram Packets (UDP) far more reliable, as long as there are no time or other constraints on delivery. The TV Protocol creates and responds to delayed negative acknowledgments (DNAKs), a core feature of this invention, which reduces the bandwidth that would be required for rebroadcast. Reliability is increased by allowing DNAKs to be accumulated and aggregated by the server over a longer period of time, as in 24 hours, as opposed to microseconds in traditional UDP Broadcast or UDP Multicast implementations.

Because UDP Broadcasts employing the protocol are intended for larger audiences, not all receivers have to report DNAKs back to the transmitter. This is due to the likelihood that the DNAKs that are reported are the same for all or at least a large segment of receivers. The broadcast server can choose to either rebroadcast the aggregated missing packets (based on the number of receivers that are missing blocks) or allow for the direct unicast fulfillment of the missing blocks over intranets or the Internet. The broadcast server may also allow fulfillment of individual requests by other receivers that did receive the complete package or from geographically positioned Internet servers.

The System and methodologies send and receive packets that are described in four types of Packets:

Guide Packet—provides information to the receiver about upcoming broadcasts packages; this includes descriptive information, block size, number of blocks, file size and GUID (Global unique identifier).

Data Packet—contains a GUID, a block number and a single block of data based on the predefined block size for the broadcast package packet.

Control Packet—contains authentication codes and rules for the receiver to operate by.

Response Packet—contains responses from the receiver that include DNAKs, receiver statistics and delivered data information.

The receiver ignores data that it. is not intended to receive. The TV Protocol can be used over any TCP/IP networking enabled communication medium with or without a return channel. Because of the packetized delivery structure of the TV Protocol, date file broadcasts can be completed at any time, thus allowing the broadcaster the ability to transmit missing packets at any time and through another communication medium if necessary.

The TV Protocol has a number of features and benefits including the following. The TV Protocol also creates and processes delayed negative acknowledgment (DNAKs), in contrast to the techniques of the prevailing legacy high-speed delivery practices.

The TV Protocol utilizes bandwidth to a much greater potential than legacy systems by making UDP (User Datagram Packets) far more reliable over short broadcasts, as long as there are no other constraints on delivery.

The TV Protocol increases the reliability of UDP broadcast or multicast implementations by allowing DNAKs to be accumulated and aggregated by the server over a longer period of time, as in 24 hours, as opposed to microseconds in legacy system practices.

The TV Protocol also reduces significantly the frequency of the requirement for all receivers to report DNAKs back to the TV transmitter. Because UDP broadcasts are intended for larger audiences, there is a greater probability that the DNAKs that are reported are the same for all or at least a large segment of receivers.

Further, the TV Protocol provides the broadcast server with both several options to receive any missing data packets and the decision tools to select the optimum redistribution method. The server can either choose to rebroadcast the aggregated missing packets (based on the number of receivers that are missing blocks or allow for the direct unicast fulfillment of the missing blocks over intranets or the Internet. In addition, the broadcast server may also allow the fulfillment of missing packet requests by other receivers that did receive, in fact, the complete data stream or from more efficaciously positioned Internet servers.

The protocol structures the data file broadcasts in a packetized manner, thus allowing original broadcasts, and any necessary re-broadcasts to supply missing packets, at any time and across any alternative communication medium, as necessary. The protocol can be used over any TCP/IP networking enabled communication medium with or without a return channel.

The system consists of the following functional components:

Content Management System (CMS)—A powerful and highly-efficient controller for bulk multimedia file loading and scheduling to achieve maximum efficiency of the associated high speed broadcast medium. The basis for the efficiency of this controller is a complex and interwoven system of artificial intelligence (“AI”) modules designed to receive and process customer-originated requests for specific television programming over the Internet using the inventive protocol. Upon receipt of the customer requests, the AI controller will access and retrieve the specific components of the customer requests, and missing packets as reported by DNAKs from the protocol, and group them for loading and scheduling of broadcast through the satellite uplink system. The AI interface will schedule on the basis of priorities, such as data required and size, in order to maximize the use of available satellite bandwidth. The AI interface will also operate based on priorities such as whether a particular content has been paid for or whether a subscriber has paid fees to allow receipt of the content.

Content Repository (CR)—A diverse system of content storage devices accessible by contracted content providers. It is within the Content Repository that the CMS will access multimedia files for loading, scheduling, and ultimate distribution to the requesting subscribers.

TV Receiver Components—Located typically in the private residences of subscribers, these TV Components receive and identify the diverse spectrum of the broadcasts, allowing the reception of all that which was ordered previously through the TV Receiver Components and filtering out all that which remains. The TV Receiver Components provide a variety of service functions, but they are primarily responsible for receiving the TV service and the viewing of the broadcast material for the subscriber.

Advantages of the inventive system include, but are not limited to, the following:

Improved data transmission efficiency.

Delivery of increased content availability by providing highly customized programming and selection options to end-users.

Enhanced UDP (User Datagram Protocol) reliability through the use of delayed negative acknowledgment techniques.

Cost-effective implementation and operation.

This invention is designed to increase the efficiency of binary data delivery, particularly for end-user entertainment selections, such as video, over high-speed transmission systems by reducing dramatically the cost and complexity of the prevailing practices. These prevailing

practices are legacy delivery systems, such as cable and traditional satellite broadcasting. Replacing the current delivery practices and systems with the methodology described herein will increase significantly the reliability of non-guaranteed satellite broadcasting (UDP), a primary service of the inventive TV system.

It is therefore an object of the present invention to provide a new and improved system for subscriber-specific TV and multimedia content distribution.

It is another object of the present invention to provide a-new and improved method for delivery of non-guaranteed satellite broadcasting content.

A further object or feature of the present invention is a new and improved system to Maximize the use of available satellite bandwidth.

An even further object of the present invention is to provide a novel method of content distribution over high speed broadcast mediums.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows maybe better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a system logical diagram;

FIG. 2 is a network physical diagram;

FIG. 3 is a system overview;

FIG. 4 is a broadcast with dead end supplementation overview;

FIG. 5 is a broadcast with peer supplementation data flow overview;

FIG. 6 is a TV system process flowchart;

FIG. 7 is an example of the dynamic bandwidth allocation method of the invention;

FIG. 8 is an example of the a La carte programming available with the inventive system;

FIG. 9 is an example of the protocol DNAKs for content delivery of lost packets.

### GLOSSARY OF TERMS USED IN THE DISCLOSURE

Aggregated DNAK Listener Database: a database where information from DNAK Listeners is aggregated and stored for further analysis.

Affival Queue: a database on a receiver that is used to maintain a list of global unique identifiers and their associated statuses for the purpose of storage analysis.

Available Content Database: a database local to the receiver that contains information relative to completed content packages that are available for play-back or use.

Binary file: computer data stored in the binary numbering system.

Broadcast a method of sending data to one or more recipients without allowing for acknowledgement.

Channel: a route of communications or access; a traditional streaming broadcast.

Client application: an application running on a personal computer or workstation that relies on the server to perform certain functions.

Content: movies, music, rich channels, games and any other binary data.

Client Management Database: a database that holds client management information regarding billing, receiver equipment and subscriptions.

Content Management Server: a cluster of load balancing servers that run distributed service software.

Content Management System: a network of servers and clusters of servers that allow Management and broadcasting of the TV system.

Content Package: a collection of binary files that may contain one or more movies, shows, music, images, web pages, interactive content or video games.

Content providers: content producers, television networks, studios and artists.

Content repository: a file server with large storage capacities and database that contains metadata regarding the files stored on the server.

Content Scheduling Database: a database that maintains a schedule of content that is to be transmitted through the TV System.

Content staging: a server that functions as queue manager and file collection point for content packages to be prepared and buffered for broadcast.

Content streaming: data delivered in real time.

Data stream: a binary file transfer.

DNAK: delayed negative acknowledgment

DNAK: Listener: a server that can receive and store client DNAKs for further analysis.

DVB/LP encapsulator: an industry standard device that prepares TCP/IP packets for transmission over Satellite or other DVB enabled platform.

Encoding: the process of digitizing video or audio between different file formats or media.

Forward error correction: interleaving redundant data bits into a file for the purpose of reducing loss incurred from multicasting in an unreliable environment.

Headend: point of origin for broadcasting.

Linear broadcasting: traditional broadcasting.

MAC: media access control or physical address is a quasi unique identifier attached to most network and satellite adapters.

Metadata: information about data and datasets.

Multicast: a method of broadcasting that allows for acknowledgments to be received and managed.

Packet: the small amount of TCP/IP data.

RAM Disk Broadcast Buffer: a virtual storage device created in a computers random access memory by the server software that allows an uninterrupted flow of data directly to the DVB/IP encapsulator.

Receiver: a computer or set top box device that is capable of running the Client software.

Rich channels: large collection of multimedia content considered as a package. Developed in the same manner as a website or interactive DVD but delivered and played locally after being delivered in its entirety to the client.

Unicast: a method of sending data between two end points with acknowledgments.

Uplink: a ground station that has interne connectivity and equipment that allows satellite signals to be transmitted.

### DETAILED DESCRIPTION OF THE INVENTION

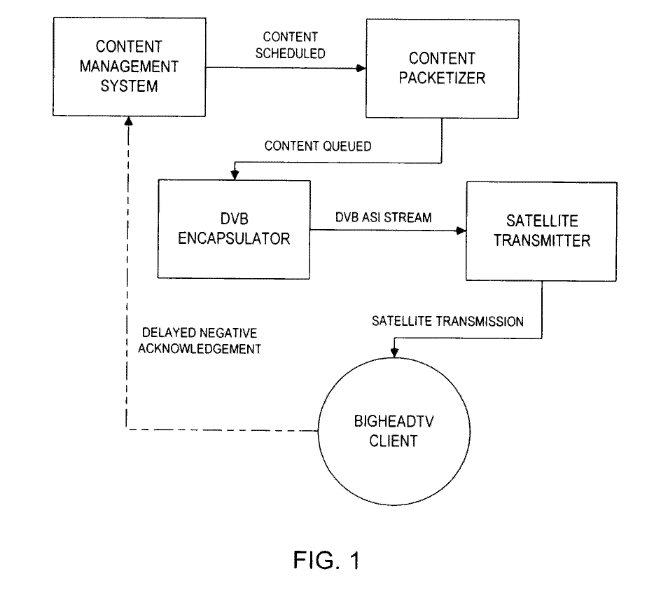

Referring to FIGS. 1 through 9, wherein like reference numerals refer to like components in the various views, there is illustrated therein a new and improved system for subscriber-specific TV and multimedia content distribution over high speed broadcast mediums. Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

FIG. 1 is a system logical diagram;

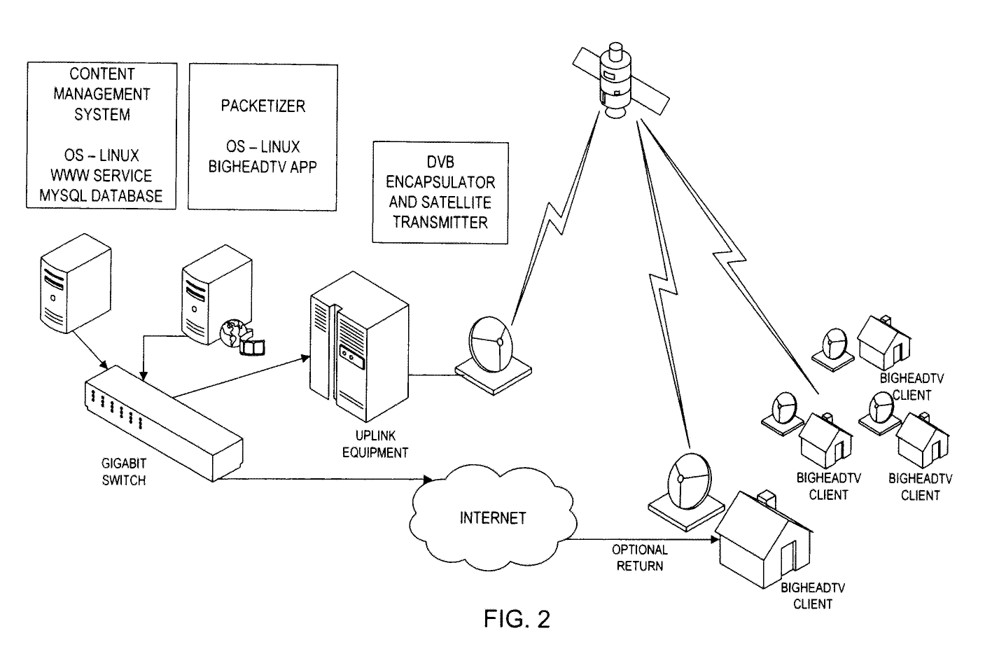

FIG. 2 is a network physical diagram;

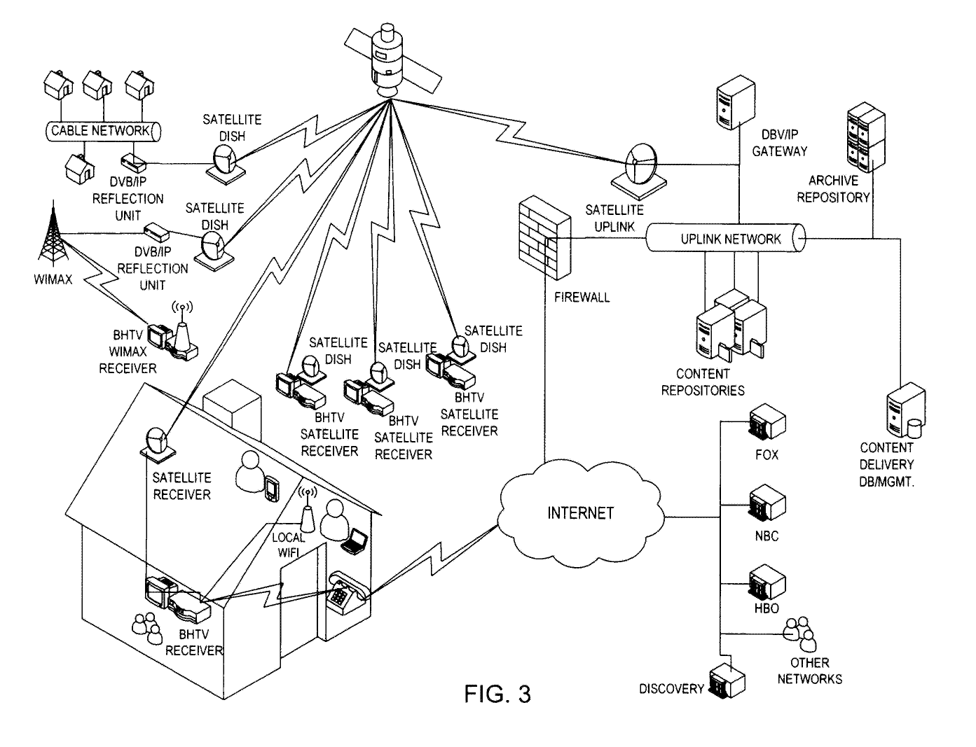

FIG. 3 is a system overview;

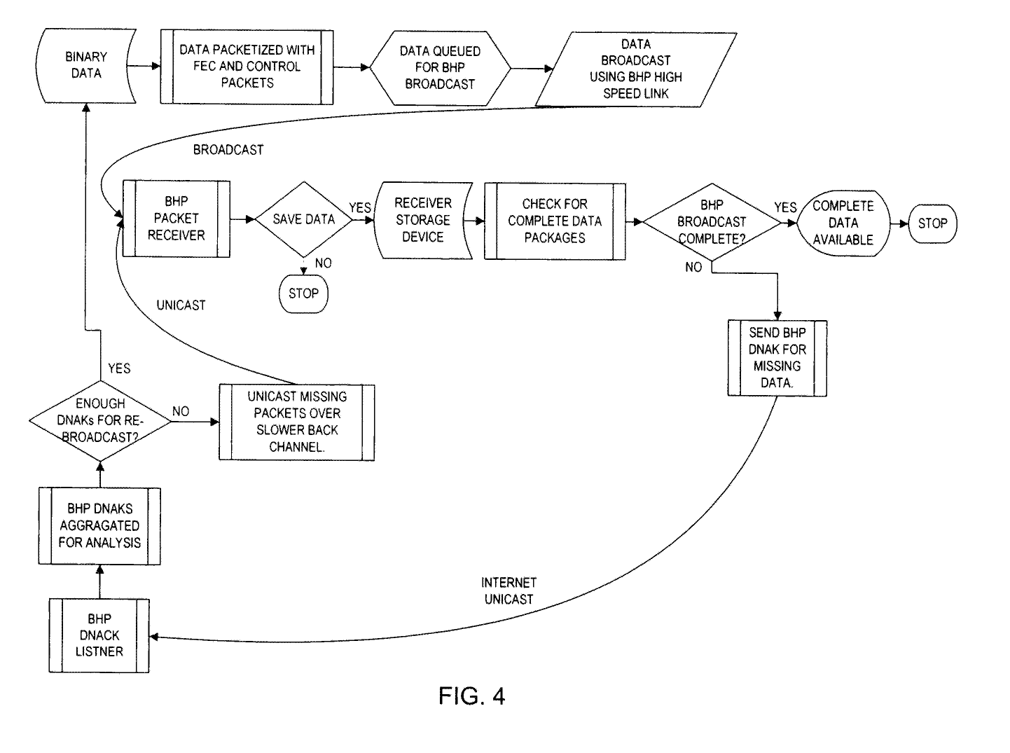

FIG. 4 is a broadcast with dead end supplementation overview;

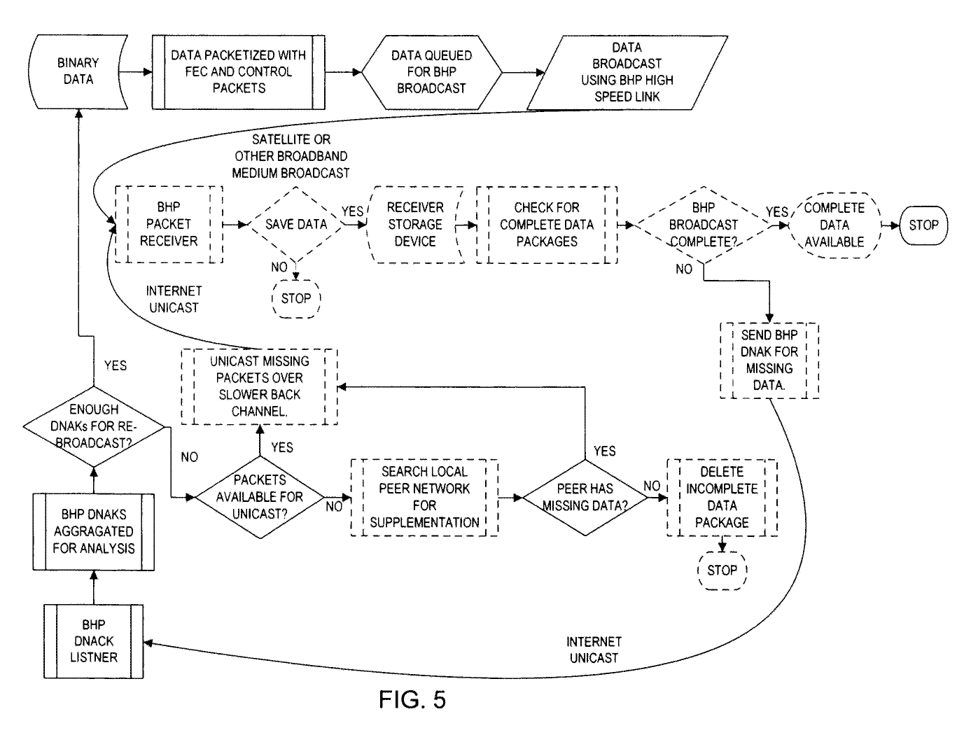

FIG. 5 is a broadcast with peer supplementation data flow overview;

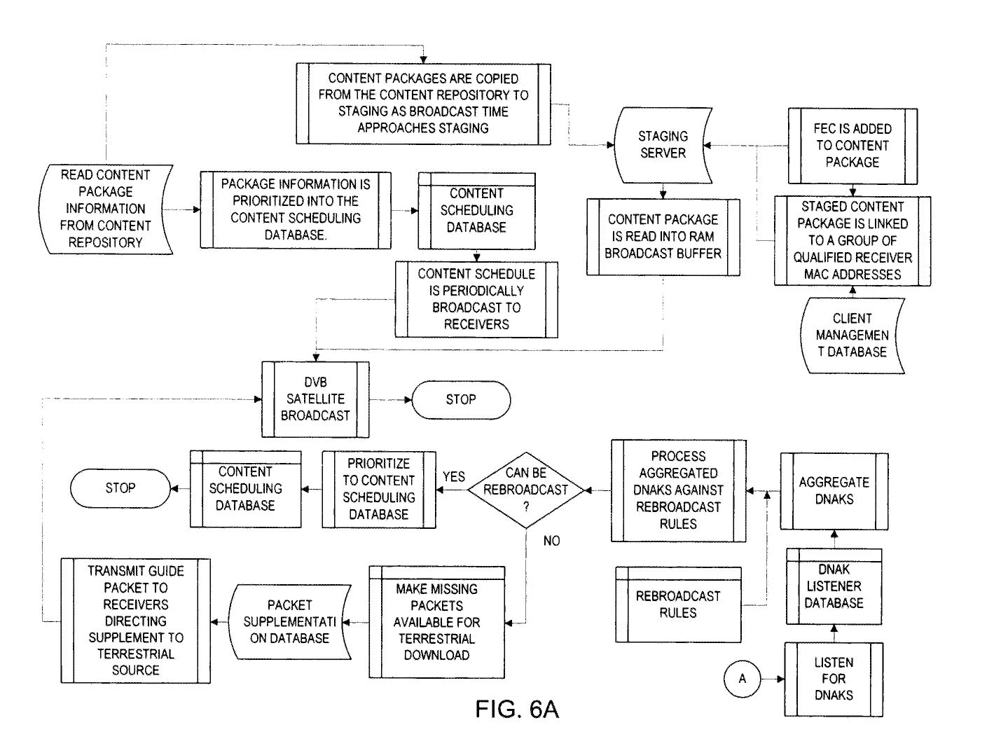

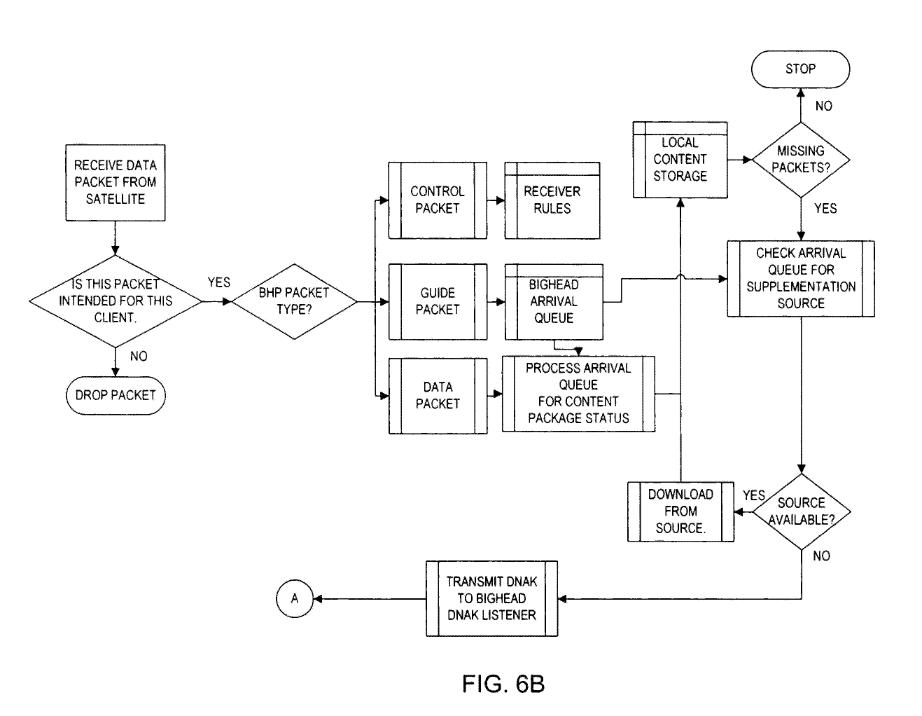

FIG. 6 is a TV system process flowchart;

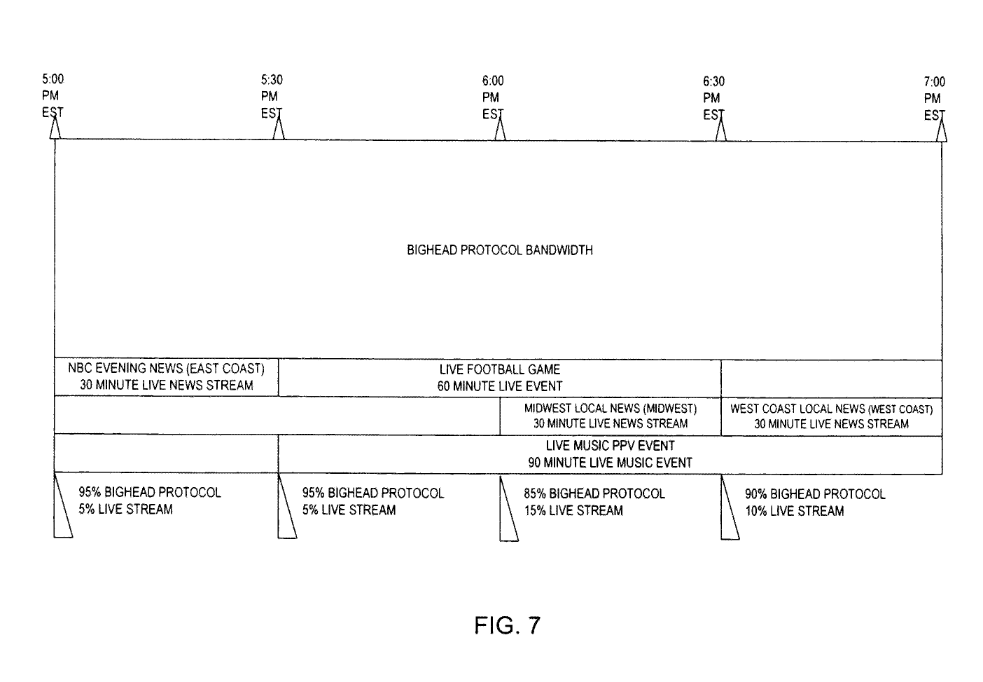

FIG. 7 is an example of the dynamic bandwidth allocation method of the invention;

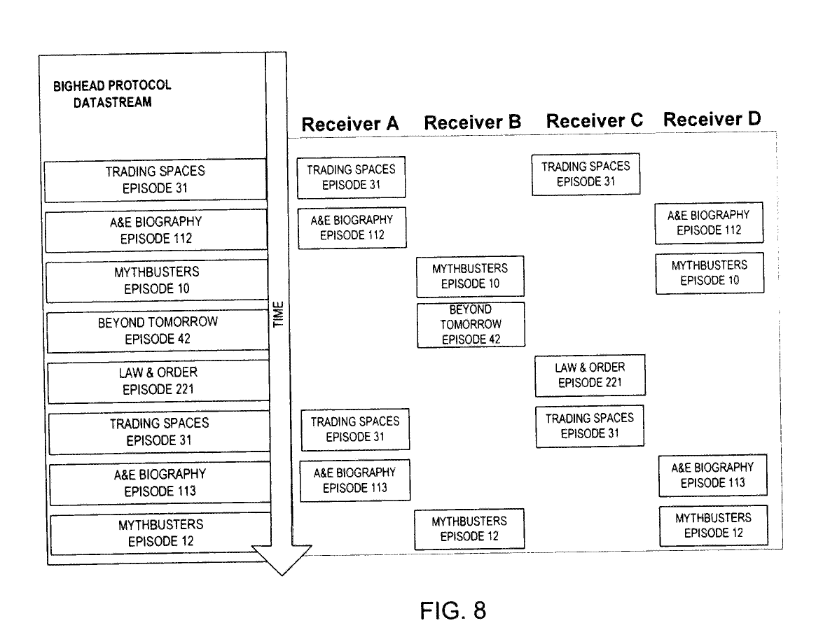

FIG. 8 is an example of the a la carte programming available with the inventive system; and

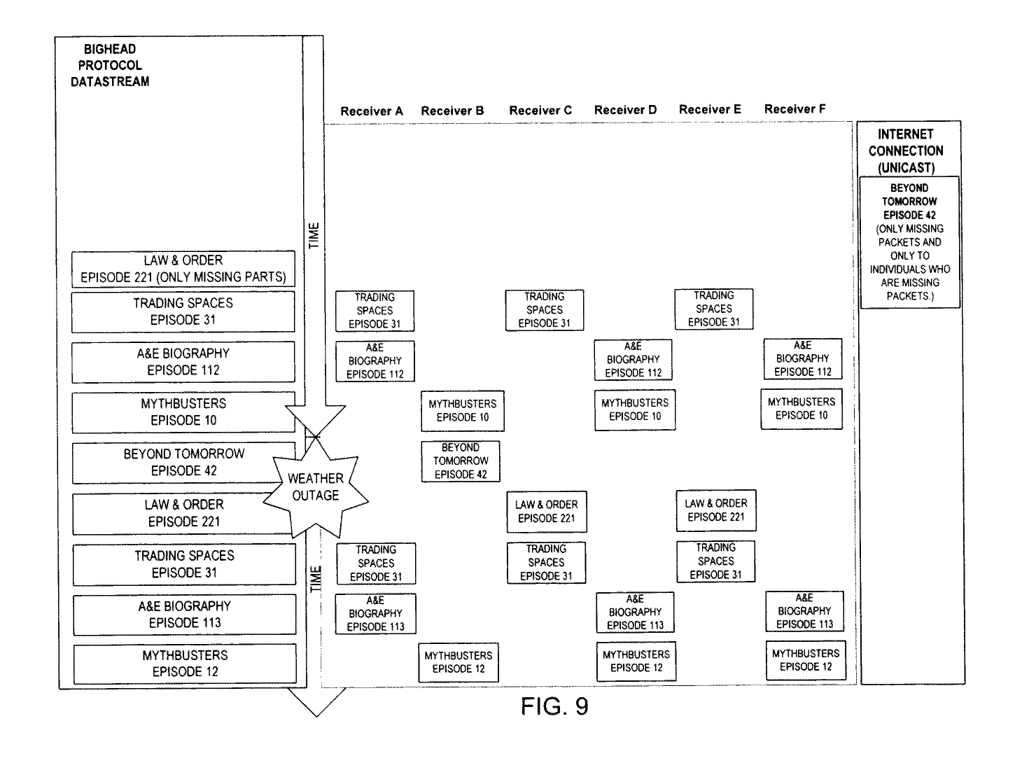

FIG. 9 is an example of the protocol DNAKs for content delivery of lost packets.

The following is a step by step description of a first preferred embodiment of the inventive system and method:

Step 1—Get content into the System

Content can be delivered to the System in a variety of ways. A preferred method would be that content is uploaded to the TV's content repositories using industry standard protocols such as FTP and HTTP over secure SSH tunnels thru the Internet from content providers such as HBO, NBC, Fox, HGTV, etc. These servers are standard file high capacity file servers.

Alternative methods of content delivery include:

Physical media—is delivered to the facilities via the postal service for encoding uploading to the content provider's repository by analysts or

Recorded from existing streams—Content may be encoded by analysts directly from an existing satellite, broadband, cable or digital stream then saved to the content provider's content repository.

In providing content to the system, content that is stored on the content providers Content Repository is made available to the content provider via a web based Content Management System. This is a PHP/MySQL web application that allows the content provider to manipulate their uploaded content in the TV system into content packages with descriptive information, size, longevity, priority, scheduling and subscription rates. This information will be used later when content is made available to TV subscribers.

Step 2—Prioritize and prepare with the Content Management System

The Content Management System periodically reads database information from Content providers' Content Repositories, specifically, information regarding one or more Content Package's priority, size, number of subscribers, preferred schedule and content longevity.

The Content Management System allows that information is periodically compiled from all content provider Content Repositories into the Primary Content Scheduling Database that resides on the Content Management Server. The Content Management System constantly monitors and tunes the schedule of Content Packages for broadcast.

Each Content Package is assigned a random global unique identifier and an estimated broadcast time by the Content Management System.

Content Packages that are within ten (10) minutes of broadcast time cannot be altered in anyway due to staging processes that prepare the Content Package for broadcast. However the content package can be postponed or canceled at anytime before one (1) minute of transmission.

The Content Package is linked to a group of qualified receiver MAC addresses allowed to receive the content. This information is derived from the Client Management Database based on subscriptions and payment status of subscribers; it is periodically broadcasted to receivers using the Protocol's Control Packet type.

This broadcast schedule information is periodically broadcast, such as through the satellite, using the Protocol's Guide packet type.

Step 3—Stage and broadcast content package using the Protocol

The Content Management System's Staging Server reads Content Package information from the Primary Content Scheduling Database which it uses as a broadcast queue.

As a Content Package's broadcast time approaches the Content Package's data files are copied from the Content Repository to the Content Management System's Staging Server.

An adjustable amount of Forward Error Correction is added to the Content Package as it is read into a RAM disk based broadcast buffer. A RAM disk based buffer is used to ensure the constant maximum bit rate is maintained by the Content Management System's Staging server to the DVB/IP encapsulator.

Content Package data is broadcast from the RAM Disk Buffer using the Protocol using UDP as the underlying transport protocol. This data is broadcast to the DVB/IP encapsulator and to the satellite transmitter as a high bandwidth data stream. The DVB Satellite is the preferred medium of broadcast however any high bandwidth capacity medium would be compatible.

Step 4—Receive DVB Satellite Data Stream

A DVB Satellite Receiver consists of a CPU, storage device, video output device, DVB Satellite tuner, industry standard Ku band satellite receiver antenna and an operating system capable of running the Client Software.

The current preferred receiver is Intel Pentium IV processor based computer with a 500 GB hard disk drive, 1 GB RAM, NVidia 6800GTX video card, B2C2 DVB receiver card connected to a 60 cm to 90 cm Ku band antenna, a Linux based operating system and the Linux port of the Client Software.

In the workings of the system and methodologies, the TV Receiver periodically receives Control and Guide Packets.

Control Packets are received and processed into rules that govern the reception of Data packets. The Control Packets are encrypted and authenticated using industry standard practices and technologies.

Guide Packets are received and processed into a local Arrival Queue. The Guide Packet contains information regarding content package's priority, size and number of expected packets.

Data Packets are received and processed for storage only if the packet is part of a Content Package that the Receiver is allowed to receive based on rules that have been configured in previously received Control Packets. If the Packet is not allowed, then it is ignored, and thus lost.

If the Content Packet is allowed, it is then passed to the Arrival Queue for further processing. The Arrival Queue processes Packets and determines in what Content Packages the data packet belongs.

As Content Package Data packets are processed through the Arrival Queue they are stored directly the receiver's mass storage device as binary files in the correct order based on data offset positions provided in the Protocol's Data Packet header. This allows for efficient Delayed Negative Acknowledgment processing.

Step 5—Analyze Arrival Queue for DNAK Processing

A worker process within the Client Software monitors the Arrival Queue for completed Content Packages or for packages that have been idle or incomplete for a configurable period of time.

Completed Packages are analyzed for authenticity and data integrity, once the Content Package is confirmed it's descriptive, longevity and content provider preferred availability date information is added to the receiver's Available Content Database and in turn its local guide/schedule for play back or use by the consumer/end user until the Content Package's longevity period (which was received by the client in earlier protocol Guide packets) has expired or the user chooses to remove the content package.

Incomplete, corrupt or missing packages are identified based on two primary factors. 1.) Information broadcasted to the receiver's Arrival Queue by protocol Guide packets that the broadcast has finished or 2.) Analysis of the complete Content Packages for corrupt or missing data packets.

The Client software compiles Response Packets that contain Delayed Negative Acknowledgments (DNAKs) for missing or corrupt packets. The Control Packet contains the global unique identifier of the package and the packet number(s) of missing packets.

If the Receiver has a return path to the TV System then these DNAKS are transmitted back to the TV System.

If the receiver does not have a return path to the TV System then these content packages are kept in the Arrival Queue until the content package's longevity period (which was received by the client in earlier protocol Guide packets) has expired or until storage space is needed.

Step 6—Receive and aggregate DNAKS from Receivers via the Internet

The TV System exposes DNAK Listener Servers (DNAK Listeners) to receive DNAKs from authorized TV Clients (as reported from the Client Management Database) via the Internet.

These DNAK Listeners receive and store DNAKs in to a local DNAK database with info that includes: Receiver's MAC address (from the DNAK), a global unique identifier of the content package (from the DNAK), byte offset of the missing packets (from the DNAK) and timestamp of the arrival of the DNAK.

The TV Content Management System periodically runs worker processes that gather and aggregate DNAKs from DNAK Listener databases into the Aggregated DNAK Listener Database. The DNAKs are counted and combined into groupings of offsets that follow predefined rules.

For a simple example, 40000 DNAKs are recorded for Content Package A would be aggregated as shown below.

| Original DNAKs | Aggregated |
|---|---|
| 1,000 DNAKs for offsets 200 to 250 | 2,000 receivers missing packets |
| | 200 to 260 |
| 1,000 DNAKs for offsets 240 to 260 | 38,000 receivers missing packets |
| | 380 to 500 |
| 23,000 DNAKS offsets 380 to 400 | |
| 15,000 DNAKs offset 400 to 500 | |

Step 7—Fulfill missing packets of content packages to Receivers

The Content Management System periodically runs worker processes that analyze the Aggregated DNAK Listener Database based on defined rules to determine the best course of action to deliver the missing packets to the Receivers most efficiently. Using the simple example above, the rules defined may determine the following:

| Aggregated | Delivery Method |
|---|---|
| 2,000 receivers missing packets | Available for download terrestrially |
| 200 to 260 | Will be rebroadcast via satellite |
| 38,000 receivers missing packets | |
| 380 to 500 | |

If the aggregated packets are supplied to the receivers terrestrially, then a Protocol Guide Packet is broadcast telling all interested receivers the availability of the missing packets.

If the aggregated packets are to be rebroadcast, then a rebroadcast request is added to the Primary Content Scheduling Database to rebroadcast only the missing offsets. In the example above it would only be the offsets between 380 and 500.

The inventive system and method provides:

A comprehensive system for subscriber-specific TV and multimedia programming selection and distribution that allows the individual subscriber to order television and multimedia content for focused delivery to their subscription site. This system employs a protocol, bulk compression algorithms, efficient content management, and optimized queue management, instead of normal linear broadcasting or content streaming, to deliver content to subscribers in a small fraction of the time required by standard industry methods.

An automated method for receiving and managing proprietary TV and multimedia content files, including any required metadata and priority components, from diverse parties in preparation for easy extraction, scheduling, and delivery to requesting subscribers. This method will facilitate the collection of the metadata, or information describing the nature of the received content, as well as transmission priority information. Content, in the form of compressed computer files, will be uploaded into the Content Repositories. This web server application allows content providers the ability to upload and manage their available video files, rich channel files, and broadcasting priorities, from any location on the internet. Also, files may be uploaded into the system through courier service submissions to the network center. [161] A method for building broadcast (multicast) play lists, from available content (submitted previously by commercial and other sources) such that files are transmitted to subscribers only one time (or as needed to help an individual use). Required files are leaded into the Content Repositories and uplinked to a satellite or other high bandwidth connection using the TV Protocol. This protocol allows the TV system to collect and aggregate DNAKS (Delayed negative acknowledgments) from a subscriber base to allow efficient use of the high speed bandwidth. It also uses automated scheduling systems within the network center to plan and build uplink schedules. It takes binary data files and adds forward error correction then broadcast the file to all TV systems listening using the TV Protocol.

A method for broadcasting content one time to many recipients for the efficient transfer to subscribers, using the protocol and formats within the system and TV Protocol. It is this method for reducing the amount of material that is broadcast repetitively as in a streaming system that allows transmission times dramatically less than competitive methods of content delivery.

A method for receiving bulk content at the subscriber site. Properly certified receivers installed at the subscriber site will listen for and receive the content from the satellite or high speed medium using the TV Protocol. The receiver will then save the data it is authorized to receive in binary data files on the receiver.

A method for managing and viewing content stored on the subscriber's local Receiver. This local Receiver consists of the Receiver components to which reference was made previously. Viewing the contents stored within the Receiver components is facilitated by the Timeless Program Guide. This component of the receiver allows users to manage what channels or file deliveries they wish to receive, save, and view. While still providing a familiar program guide that matches traditional streaming broadcast schedules. The Guide shows not only content that is current and upcoming but it allows the user to view content that has already been broadcast from previous dates and times. When a user is authorized to view content, the receiver can play the content to either a TV or computer, or any device using file transfers.

A method for allocating bandwidth dynamically, thereby increasing efficiency in allowing live stream events such as news and sports to share the same bandwidth that the TV Protocol uses.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A method for subscriber-specific TV and multimedia programming selection and distribution enabling an individual subscriber to order television and multimedia content for focused delivery to their subscription site, the method comprising the steps of:
providing a protocol to receive and process subscriber-originated requests for specific programming;
retrieving the components of the requests;
retrieving missing packets as reported by DNAKs; and
grouping the missing packets for loading and scheduling of broadcast through an uplink.

2. The method of claim 1 further including providing bulk compression algorithms.

3. The method of claim 1 further including providing content management.

4. The method of claim 1 further including optimizing queue management.

5. An automated method for receiving and managing proprietary TV and multimedia content files from diverse parties in preparation for extraction, scheduling, and delivery to requesting subscribers, the method comprising the steps of:
uploading content into content repositories; and
prioritizing the content with a content management system.

6. The method of claim 5, further comprising the step of:
aggregating delayed negative acknowledgements from a subscriber base.

7. The method of claim 5 further comprising the step of:
providing automated scheduling systems within the network center to plan and build uplink schedules.

8. The method of claim 5 further comprising the step of:
adding forward error correction to binary data files, and broadcasting the file to all TV systems listening using the protocol.

9. The method of claim 5, further comprising the step of:
providing a protocol for reducing the amount of material that is broadcast repetitively.

10. The method of claim 5, further comprising the steps of:
installing certified receivers at the subscriber site;
listening for and receiving the content from the high speed medium using a protocol; and
saving the data a receiver is authorized to receive in binary data filed on the receiver.

11. The method of claim 5, further comprising the steps of:
providing a program guide enabling users to manage what channels or file deliveries users wish to receive, save, and view;
providing authorization for the user to view content; and
playing the content.

12. A system for subscriber-specific TV and multimedia programming selection and distribution comprising:
an uploader to upload content to a repository;
a prioritizer to prioritize the content;
a stager and broadcaster to stage and broadcast the content using a protocol;
a subscriber receiver to receive the broadcast content;
an analyzer to analyze the received content for DNAK processing;
a receiver to receive and aggregate DNAKs via the internet; and
a rebroadcaster to fulfill missing content packets to said subscriber receiver.
